(19) United States
(12) Patent Application Publication
(10) Pub. No.: US 2003/0147248 A1
(43) Pub. Date: Aug. 7, 2003

(54) Highway vehicle illumination

(76) Inventor: Fradique Lee-Duarte, Ciudad de Guatemala (GT)

Correspondence Address: FISH & NEAVE, 1251 AVENUE OF THE AMERICAS, 50TH FLOOR, NEW YORK, NY, 10020-1105, US

(21) Appl. No.: 10/068,467

(22) Filed: Feb. 5, 2002

(51) Int. Cl. B60Q 1/00

(52) U.S. Cl. 362/487

(57) ABSTRACT

A highway vehicle is equipped with an additional directed light for illuminating the area to the side and/or rear of the vehicle where another approaching vehicle will pass by the first vehicle. The additional light helps the driver of the other vehicle see the area into which he or she is driving. The additional light is used at night when the driver of the other vehicle may have vision impaired by the headlights of the vehicle equipped with the additional light and by the fact that the other vehicle's headlights have been reduced to their “low beam” setting. Circuitry for automatically turning the additional light on and off may be provided. Adjustable mounting for the additional light may be provided.

### BACKGROUND OF THE INVENTION

This invention relates to lighting for use on highway vehicles, and more particularly to vehicle lighting that reduces the adverse effect (especially at night) of one vehicle's headlights on the vision of the driver of another vehicle approaching from the opposite direction.

When two vehicles approach one another from opposite directions at night with their headlights on, the headlights of each vehicle generally have at least some adverse effect on the ability of each vehicle's driver to see the road ahead, especially alongside and beyond the other vehicle. The “low beam” setting of a vehicle's headlights is intended to reduce this “blinding” or “dazzling” effect on the on-coming driver, but there may still be a significant adverse effect on the on-coming driver's vision. Moreover, each driver has also typically switched his or her headlights from the “high beam” setting to the “low beam” setting, thereby reducing the amount of light his or her headlights shed on the road ahead, especially the road alongside and beyond the other vehicle. The ability of a driver, whose vision is thus impaired and whose own vehicle light is thus reduced, to see obstacles or other hazards in the road ahead is thereby undesirably diminished. This can contribute to the hazards of driving at night.

### SUMMARY OF THE INVENTION

In accordance with this invention, a highway vehicle is provided with at least one additional light that is located and directed so as to illuminate an area alongside and/or toward the rear of the vehicle on the side of the vehicle that other on-coming vehicles pass. The additional light is preferably a relatively focused or directed white light (e.g., like a vehicle headlight or a spotlight). The additional light is preferably directed away from the front of the vehicle, and is further preferably directed alongside and/or toward the rear of the vehicle. The highway surface alongside and/or to the rear of the vehicle is preferably included in the area illuminated by the additional light. The intensity of the additional light is preferably generally like a typical vehicle headlight (e.g., the “low beam” of a vehicle headlight) or at least about 25% of the intensity of such a typical vehicle headlight. More preferably, the intensity of the additional light is at least about 50% of the intensity of the “high beam” of a vehicle headlight. The vehicle may be equipped with circuitry for automatically turning on the additional light under certain predetermined conditions. For example, these conditions may include (1) the vehicle's headlights are on and (2) another vehicle is approaching. A further condition that may be required is (3) the other approaching vehicle has its headlights on. The circuitry for automatically turning on the additional light may keep the additional light on for a predetermined time after it comes on or after one or more of the “turn on” conditions are no longer true. The additional light may be mounted on the vehicle on an adjustable support. The additional light (and other associated elements) may be original vehicle equipment, or the additional light (and other associated elements) may be added to the vehicle later as an “after market” product.

Further features of the invention, its nature and various advantages will be more apparent from the accompanying drawings and the following detailed description.

### BRIEF DESCRIPTION OF THE DRAWINGS

FIG. 1 is a simplified plan view showing one of two approaching vehicles equipped with an additional light in accordance with an illustrative embodiment of the invention.

FIG. 2 is a simplified elevational view taken along the line 2-2 in FIG. 1.

FIG. 3 is a simplified elevational view taken along the line 3-3 in FIG. 1.

FIG. 4 is a simplified block diagram of an illustrative embodiment of circuitry for controlling an additional vehicle light in accordance with certain aspects of the invention.

FIG. 5 is a simplified perspective view of an illustrative embodiment of a structure for mounting an additional light on a vehicle in accordance with certain aspects of the invention.

### DETAILED DESCRIPTION

FIG. 1 shows a short stretch of highway 10 along which two vehicles 20 and 30 are approaching one another from opposite directions in respective traffic lanes 10a and 10b on respective opposite sides of broken highway striping line 12. There is no special significance to the use of the word “highway” herein. The invention is equally applicable to any type of surface on which vehicles may move (e.g., private roads, unpaved roads, etc.). Similarly, although FIGS. 1-3 show vehicles constructed and being operated according to the convention used (at least for most vehicles) in continental North and South America and in continental Europe, for example, it will be readily apparent to those skilled in the art how the invention can be adapted for vehicles constructed and operated according to the other convention used, for example, in Great Britain and Japan. In particular, FIGS. 1-3 show the invention applied to vehicles arranged for driving on the right side of the road (e.g., as in the United States). It will be apparent that the elements of the invention can be shifted to the other side of vehicles that are arranged for driving on the left side of the road (e.g., as in Great Britain). It will also be understood that although FIGS. 1-3 illustrate the invention in the context of its application to automobiles (“cars”), the invention is equally applicable to any other type of highway vehicle such as trucks of all sizes and constructions, buses, vans, sport utility vehicles, station wagons, etc.

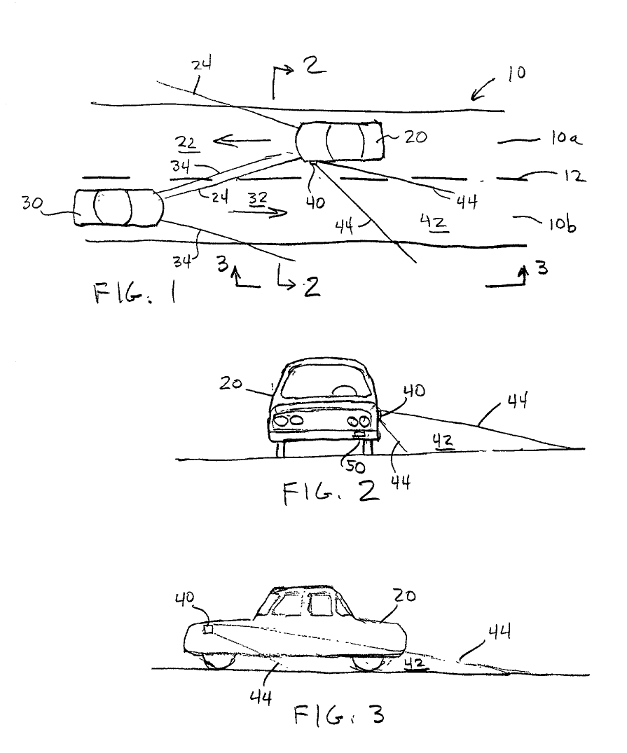

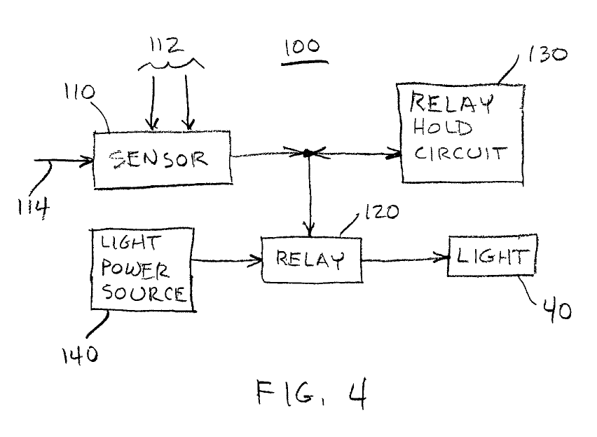

In FIG. 1 (as well as in FIGS. 2 and 3) it is assumed that it is night-time and that vehicles 20 and 30 both have their headlights on. The approximate area illuminated by the headlights of vehicle 20 is indicated by reference number 22, and the approximate area illuminated by the headlights of vehicle 30 is indicated by reference number 32. Light rays 24 indicate the approximate boundaries of area 22, and light rays 34 indicate the approximate boundaries of area 32. Because vehicles 20 and 30 are relatively close to one another, it is assumed that the headlights of both vehicles are in their low beam setting.

Although the headlights of vehicle 20 are low, they may still have an adverse effect on the ability of the driver of vehicle 30 to see the road ahead of vehicle 30 (e.g., alongside and to the rear of vehicle 20). The driver of vehicle 30 may be additionally handicapped in this regard by the fact that the headlights of vehicle 30 are in their low beam setting.

To counteract the foregoing problem, in accordance with this invention, vehicle 20 is equipped with an additional light 40 (see also FIGS. 2 and 3). In the illustrative embodiment shown in FIGS. 1-3, additional light 40 is located on the side of vehicle 20 that will be toward vehicle 30 as vehicles 20 and 30 pass one another. In other words, additional light 40 is located on the driver's side of vehicle 20. Additional light 40 is preferably an at least partly focused or directed white light (i.e., a spotlight somewhat like a headlight). It is preferably directed (a) away from the front of vehicle 20 and (b) to the side and/or toward the rear of vehicle 20 to illuminate the area 42 to the side and/or toward the rear of vehicle 20. Light rays 44 indicate the approximate boundaries of the area 42 illuminated by additional light 40.

The area 42 illuminated by additional light 40 preferably includes the portion of the traffic lane 10b (including the highway surface) ahead of vehicle 30 and to the side and/or toward the rear of vehicle 20. The exact area of coverage of additional light 40 is subject to permissible variation without departing from this invention. For example, it may include sub-areas both to the side of vehicle 20 and rearward of vehicle 20, or it may be determined that one of these two sub-areas does not need illumination and can be omitted from the coverage provided by additional light 40. Thus, for example, additional light 40 may be directed largely or entirely to illuminate traffic lane 10b rearwardly of vehicle 20, with little or no illumination to the immediate side of vehicle 20. Or, additional light 40 may also be directed to additionally provide illumination in traffic lane 10b to the immediate side of all or any portion of vehicle 20.

The purpose of additional light 40 is to give the driver of vehicle 30 additional illumination of the area into which vehicle 30 is headed. Additional light 40 will help the driver of vehicle 30 see obstacles or other hazards that may be in the path of vehicle 30 in the area illuminated by additional light 40. Additional light 40 therefore helps to reduce the blinding or dazzling effect of the headlights of vehicle 20 on the vision of the driver of vehicle 30. Additional light 40 also helps to make up for the fact that the headlights of vehicle 30 are on low beam as vehicle 30 approaches vehicle 20. For example, additional light 40 makes up for some of the illumination lost by the driver of vehicle 30 when the headlights of vehicle 30 are switched to their low beam setting.

To serve the above-stated purpose, additional light 40 preferably puts out an amount of light that is comparable to a typical vehicle headlight or at least about 25% of the light output of a typical low beam vehicle headlight. More preferably, light 40 puts out an amount of light that is at least about 50% of the light output of a high beam vehicle headlight. The exact amount of light output by additional light 40 is subject to permissible variation without departing from this invention.

The exact location of additional light 40 on vehicle 20 is also subject to permissible variation without departing from the invention. For example, although FIGS. 1-3 shows additional light 40 on the side of the front fender of vehicle 20, additional light 40 could be alternatively located at any other suitable point (e.g., elsewhere along the side of vehicle 20, on the rear of vehicle 20, or even under vehicle 20 if vehicle 20 has sufficient clearance above surface 10).

Although FIGS. 1-3 suggest the presence of only one additional light 40, it will be understood that multiple such lights may be used, or that at one location 40 multiple bulbs may be used.

Vehicle 20 is preferably also equipped with circuitry for automatically turning on additional light 40 at appropriate times. This circuitry also preferably automatically turns off additional light 40 when it is no longer needed. Thus, additional light 40 is preferably not on all the time, but rather is on only when it is needed to help the driver of an on-coming vehicle such as vehicle 30 in FIG. 1.

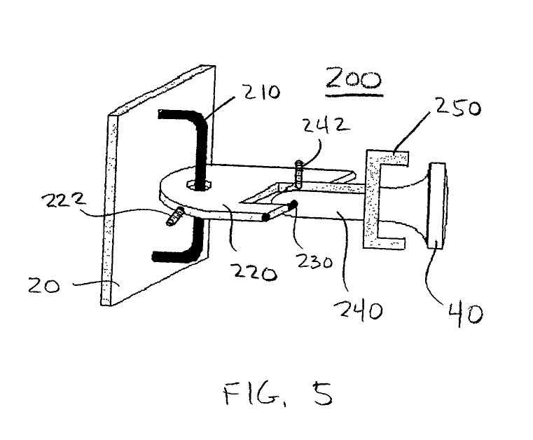

Illustrative circuitry 100 for automatically turning additional light 40 on and off is shown in FIG. 4. This circuitry may include a sensor 110 that is enabled by one or more condition-dependent inputs 112. For example, sensor 110 may be enabled when inputs 112 indicate that the headlights of vehicle 20 are on. An additional or alternative pre-condition 112 for enabling sensor 110 may be detection of ambient darkness, especially in the direction into which additional light 40 will be directed.

When enabled as described above, sensor 110 is able to respond to a further input 114 indicating the approach of another vehicle (such as vehicle 30 in FIG. 1) that may benefit from additional light 40 being turned on. For example, input 114 may be sensing the headlights of approaching vehicle 30. In that case, sensor 110 may be or include a photosensor in a light protector tunnel aimed toward approaching vehicles like vehicle 30 in FIG. 1. Alternatively or in addition, input 114 may be proximity sensing of approaching vehicle 30. An illustrative location for sensor 110 on vehicle 20 is shown in FIG. 2 at reference number 50. Location 50 is on the front of vehicle 20 toward the side of the vehicle that is nearer the center of highway 10 and therefore nearer an approaching vehicle 30.

When sensor 110 is enabled and when it detects an approaching vehicle such as vehicle 30, sensor 110 outputs a signal for activating relay 120 and also for activating relay hold circuit 130. When thus activated, relay 120 causes electrical power from light power source 140 to be applied to additional light 40, thereby turning on the additional light. Relay hold circuit 130 preferably keeps relay 120 activated for a predetermined time after sensor 110 is no longer outputting a relay-activating signal. This keeps additional light 40 lit as vehicle 30 is passing vehicle 20. A predetermined time after sensor 110 ceases to output an activating signal, relay hold circuit 130 “times out” and relay 120 is no longer activated. Additional light 40 is thereby disconnected from power source 140, which turns off the additional light.

The use of the word “relay” in connection with FIG. 4 should not be understood to mean only an electro-mechanical relay. Any type of controllable switch (e.g., a solid state switch) can be used for element 120.

Additional inputs (like 112) can be used to enable sensor 110 or circuitry 100 in general. Examples of such other inputs are the speed of vehicle 20, the speed of approach of vehicle 30, etc. For example, if analysis of these speeds indicates that only vehicle 20 is moving, there may be no need to turn on additional light 40. Circuitry 100 may include a microprocessor for performing such analysis for various inputs and making a decision as to whether or not to turn on additional light 40.

If desired, additional light 40 may be mounted on vehicle 20 using a structure that permits adjustment of additional light 40. An illustrative embodiment of such a structure 200 is shown in FIG. 5.

As shown in FIG. 5, illustrative support structure 200 for light 40 includes a substantially vertical track member 210 mounted (or mountable) on vehicle 20 (e.g., on the side of the left front fender of the vehicle). Plate 220 extends substantially horizontally out from track 210. Plate 220 is movable up and down along track 210. Plate 220 is also pivotable in a substantially horizontal plane about the substantially vertical axis of track 210. When plate 220 is in the desired vertical and horizontally pivoted position, its position can be fixed by tightening clamp element 222 against track 210.

The portion of plate 220 remote from track 210 includes substantially horizontal axle 230. Arm 240 is mounted on axle 230 for pivoting about the substantially horizontal axis of axle 230. When arm 240 is at the desired pivoted position, its position can be fixed by tightening clamp element 242 against axle 230. Light 40 is located inside light base 250 on arm 240 remote from axle 230.

From the foregoing it will be apparent that structure 200 allows light 40 to be adjusted with respect to (a) its height on vehicle 20, (b) the angle at which it points away from vehicle 20 (in a substantially horizontal plane), and (c) the angle at which it points toward the surface of highway 10 (in a substantially vertical plane).

It will be appreciated that a mounting structure like that shown in FIG. 5 does not have to be used, and that any other suitable mounting structure (including a substantially fixed mounting structure) can be used instead, if desired. It will also be appreciated that additional light 40 and other associated elements are preferably original vehicle equipment, but they may alternatively be added to the vehicle later as an “after market” product.

It will be understood that the foregoing is only illustrative of the principles of the invention and that various modifications can be made by those skilled in the art without departing from the scope and spirit of the invention. Many examples of such modifications have been given through the foregoing specification.

The invention claimed is:

1. A light for a highway vehicle for illuminating an area through which another vehicle that is coming in the opposite direction toward the first-mentioned vehicle will pass as the other vehicle passes the first-mentioned vehicle, the light being directed away from the front of the first-mentioned vehicle.

2. The light defined in claim 1 wherein the light is directed at least partly to one side of the first-mentioned vehicle, the one side being the side along which the other vehicle will pass.

3. The light defined in claim 1 wherein the light is directed at least partly toward the rear of the first-mentioned vehicle along the side of the first-mentioned vehicle that the other vehicle will pass.

4. The light defined in claim 1 wherein the light is adapted for mounting on the side of the first-mentioned vehicle that the other vehicle will pass.

5. The light defined in claim 1 wherein the light is adapted for mounting on the driver's side of the first-mentioned vehicle.

6. The light defined in claim 1 in combination with mounting structure adapted to mount the light on the first-mentioned vehicle.

7. The light defined in claim 6 wherein the mounting structure is adapted to permit adjustment in direction of the light.

8. The light defined in claim 1 in combination with light control circuitry adapted to selectively automatically turn on the light.

9. The light defined in claim 8 wherein the light control circuitry is adapted to turn on the light in response to detection of the other vehicle coming in the opposite direction toward the first-mentioned vehicle.

10. The light defined in claim 9 wherein the light control circuitry includes sensor circuitry adapted to detect light from the headlights of the other vehicle coming in the opposite direction toward the first-mentioned vehicle.

11. The light defined in claim 8 wherein the light control circuitry is further adapted to keep the light on for a time after cessation of a condition that caused the light to be turned on.

12. The light defined in claim 11 wherein the time is limited so that the light is thereafter automatically turned off.

13. The light defined in claim 1 wherein the light outputs an amount of light at least equal to about 25% of the light output by a low beam headlight of the first-mentioned vehicle.

14. The light defined in claim 1 wherein the light outputs an amount of light at least equal to about 50% of the light output by a high beam headlight of the first-mentioned vehicle.

15. A light device located on the left lateral side of a highway vehicle in order to avoid dazzling to a driver coming in another vehicle in the opposite direction, the device comprising:
a spotlight;
a structure for supporting the spotlight on the left lateral side of the first-mentioned vehicle so that the spotlight points away from the front of the first-mentioned vehicle but into an area through which the other vehicle will pass in the course of passing the first-mentioned vehicle; and
a photosensor that is enabled when the first-mentioned vehicle's headlights are turned on, and that when thus enabled, is activated by light from the headlights of the other vehicle to turn on the spotlight.

16. The light device defined in claim 15 wherein the structure is adapted to allow adjustment of the spotlight's direction.

17. The light device defined in claim 16 wherein the structure comprises:
a track adapted to allow adjustment of the height of the spotlight;
a first rotatable coupling adapted to allow adjustment of the angle of the spotlight about a substantially vertical axis; and
a second rotatable coupling adapted to allow adjustment of the angle of the spotlight about a substantially horizontal axis.

18. The light device defined in claim 15 wherein the photosensor is located in a light protector tunnel.

19. The light device defined in claim 15 wherein the structure is adapted for mounting on the left front fender of the first-mentioned vehicle.
